(19) United States
(12) Patent Application Publication
(10) Pub. No.: US 2009/0139539 A1
(43) Pub. Date: Jun. 4, 2009

(54) METHOD AND APPARATUS FOR CLEANING

(76) Inventors: Joel Heimlich, San Jose, CA (US); Alan Heimlich, San Jose, CA (US)

Correspondence Address: ALAN HEIMLICH, 5952 DIAL WAY, SAN JOSE, CA, 95129, US

(21) Appl. No.: 12/325,062

(22) Filed: Nov. 28, 2008

Related U.S. Application Data
(60) Provisional application No. 60/991,214, filed on Nov. 29, 2007.

(51) Int. Cl. B08B 7/00; B08B 5/00; B08B 13/00; B01F 15/06; B01F 13/00; B08B 1/00

(52) U.S. Cl. 134/1; 134/21; 134/7; 134/19; 134/95.1; 366/342; 366/144

(57) ABSTRACT

A method and apparatus for cleaning have been disclosed.

### RELATED APPLICATION

This patent application claims priority of U.S. Provisional Application Serial No. 60/991214 filed Nov. 29, 2007 titled “Method and Apparatus for Cleaning”, which is hereby incorporated herein by reference.

### FIELD OF THE INVENTION

The present invention pertains to cleaning. More particularly, the present invention relates to a method and apparatus for cleaning.

### BACKGROUND OF THE INVENTION

Cleaning apparatus and methods often leave behind contaminants or residue, damage the surface, or not environmentally friendly. This may present a problem.

For example a chemical process for cleaning may be Limited on the size of the area it can clean, may not be easily scalable, may be labor intensive, may use hazardous chemicals (EPA), and may be costly. This presents a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be implemented or controlled;

FIG. 2 is a block diagram of a computer system in which some embodiments of the invention may be used, implemented, or controlled; and

FIGS. 3-21 illustrate various embodiments and features of Directed Kinetic Energy Cleaning (DKEC™).

### DETAILED DESCRIPTION

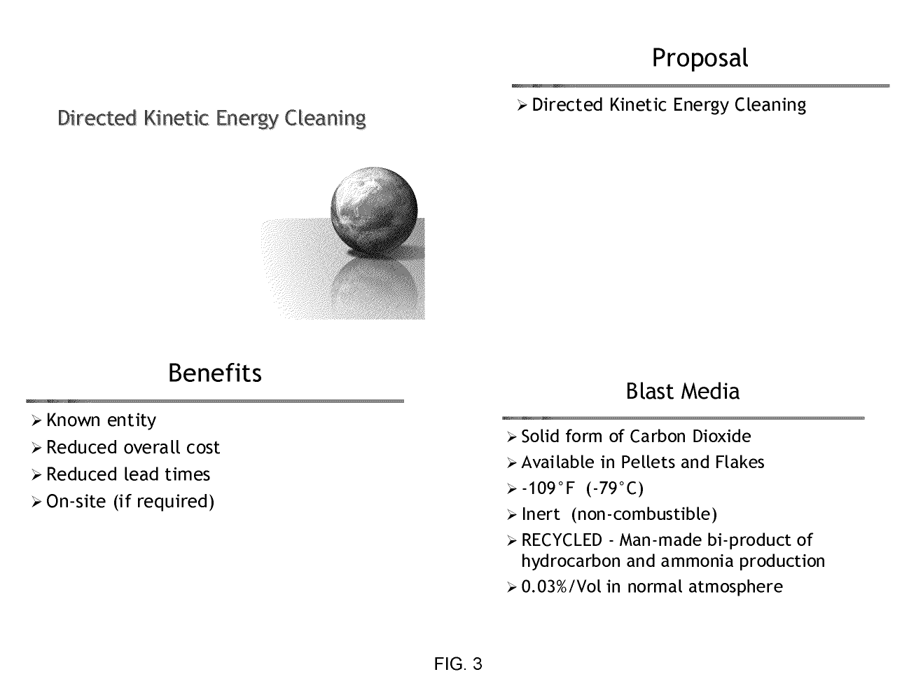

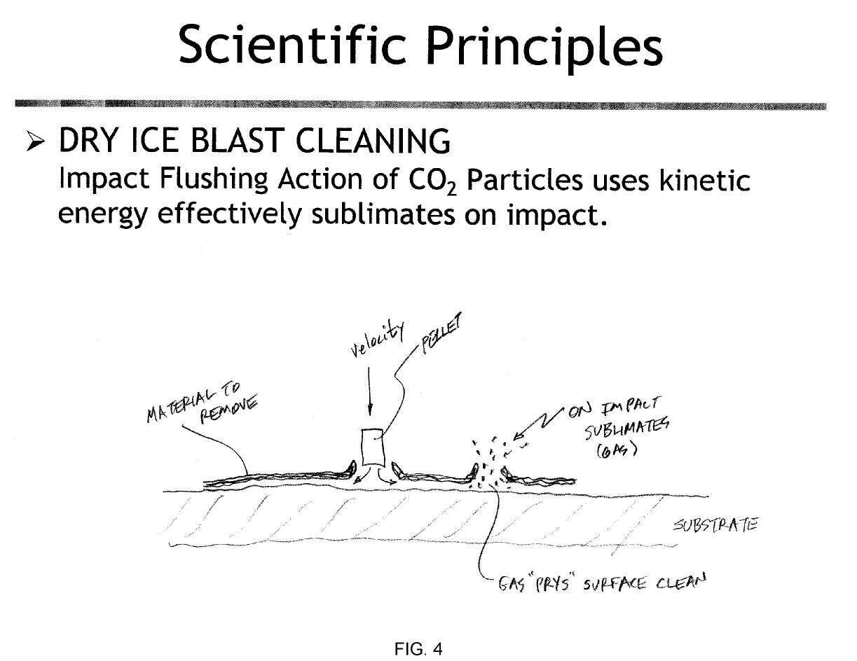

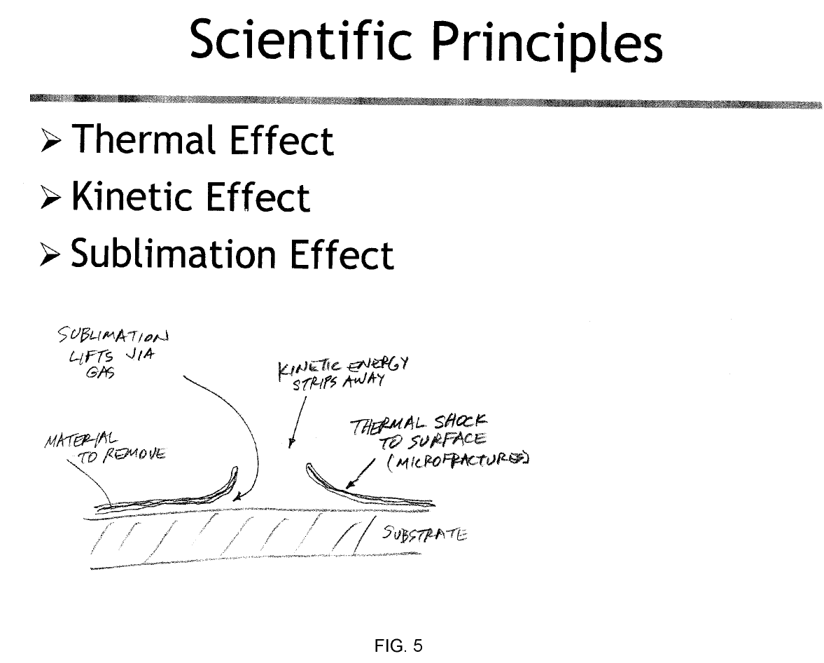

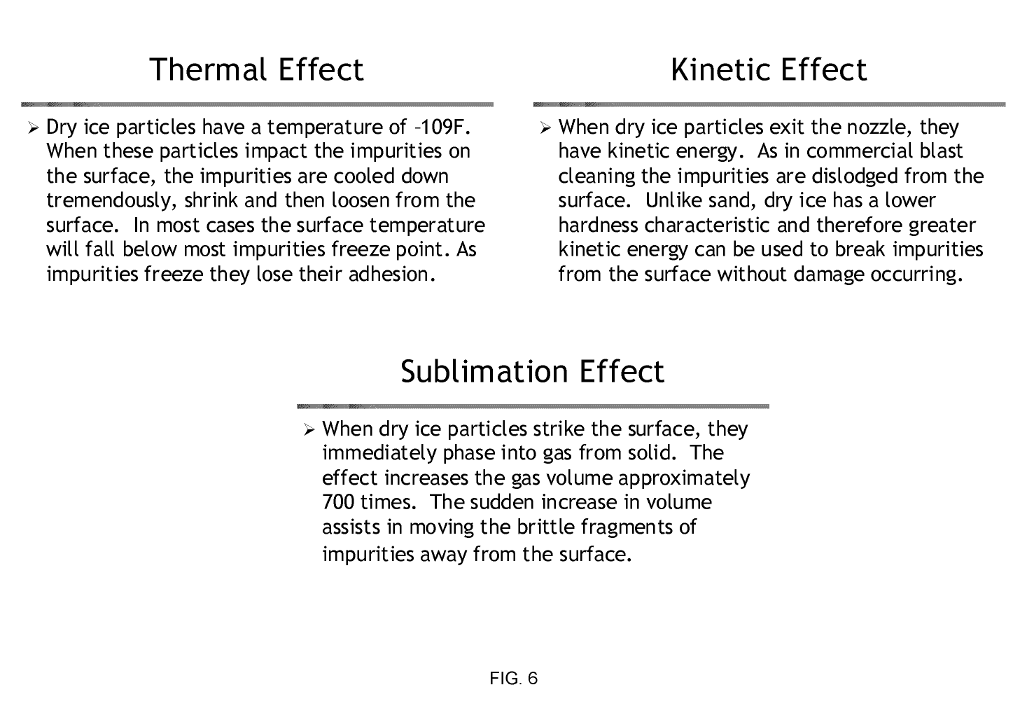

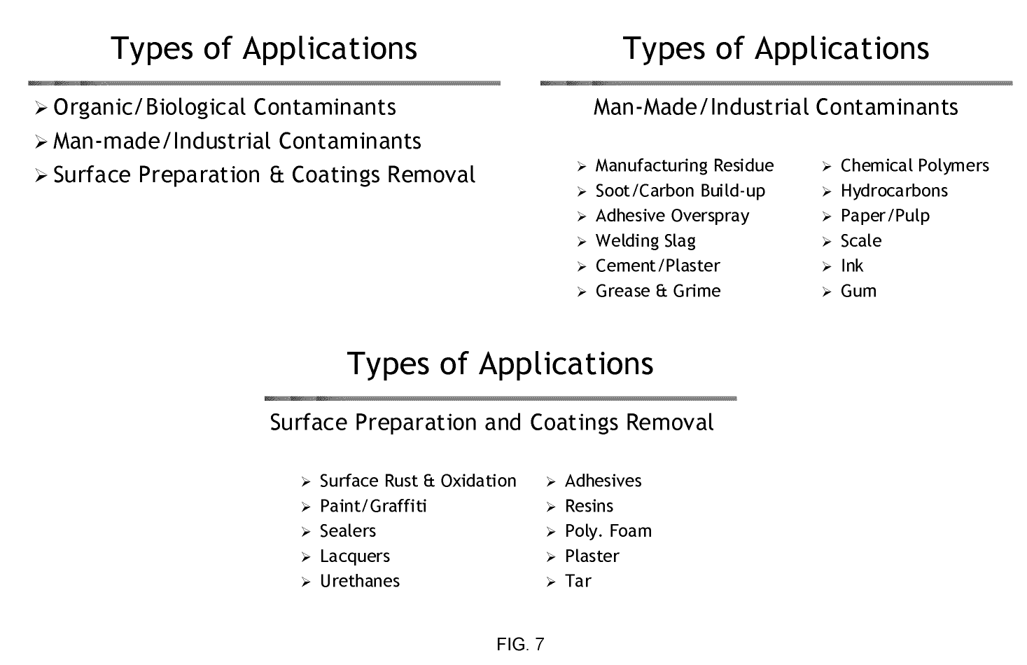

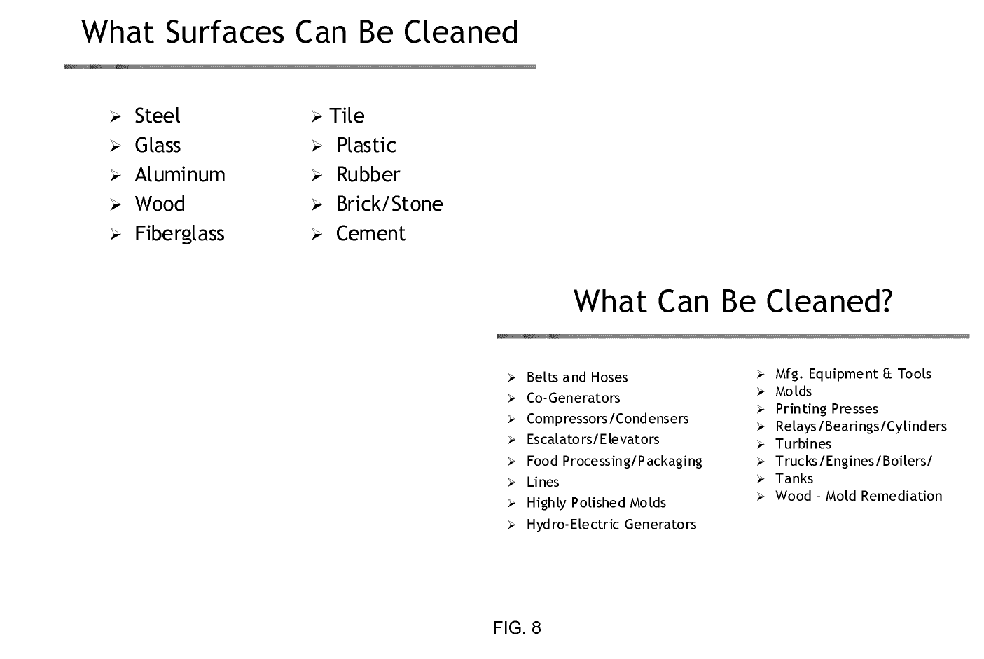

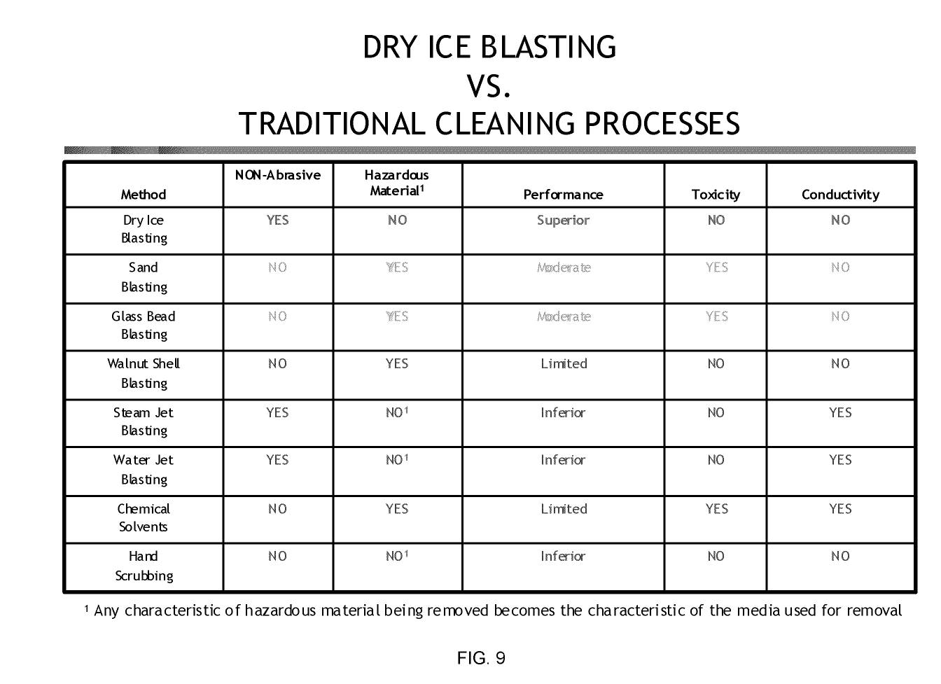

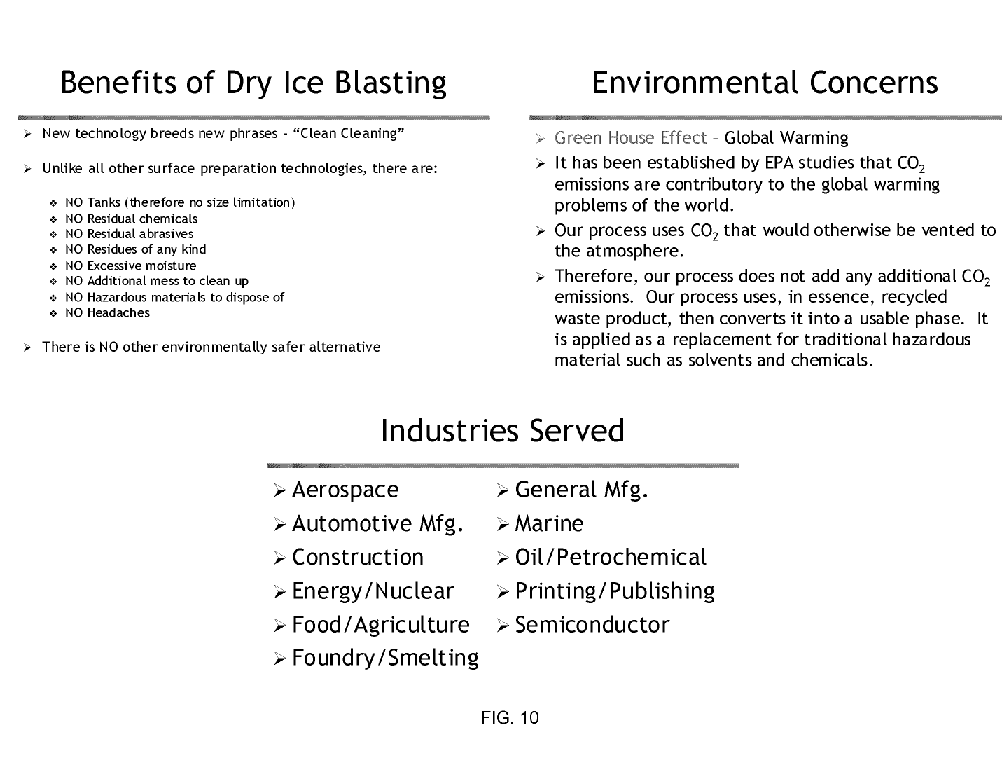

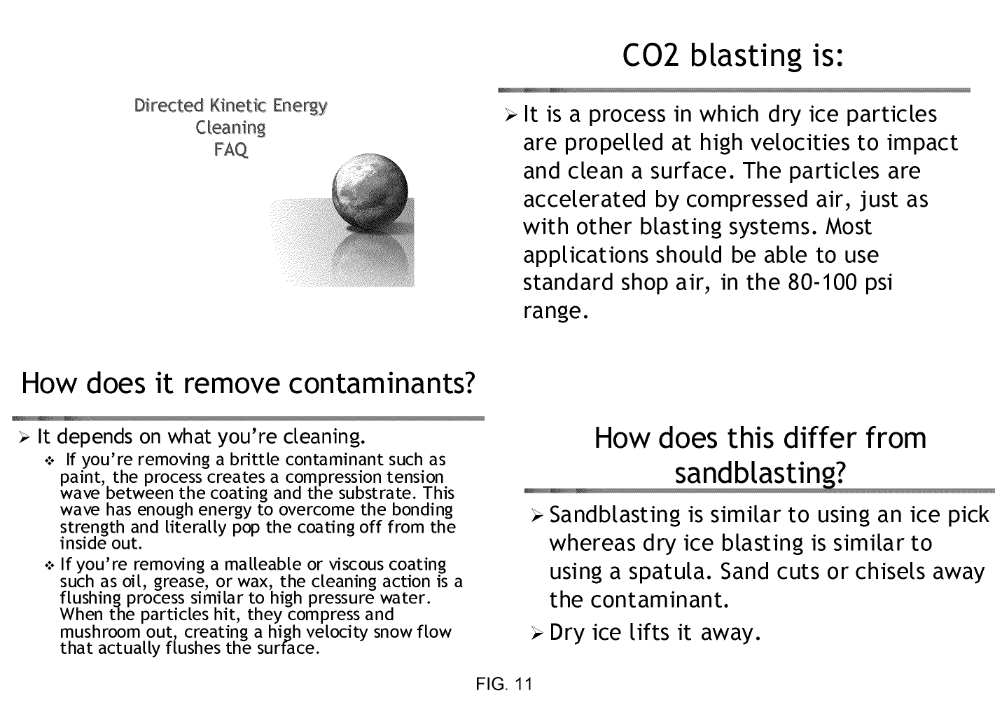

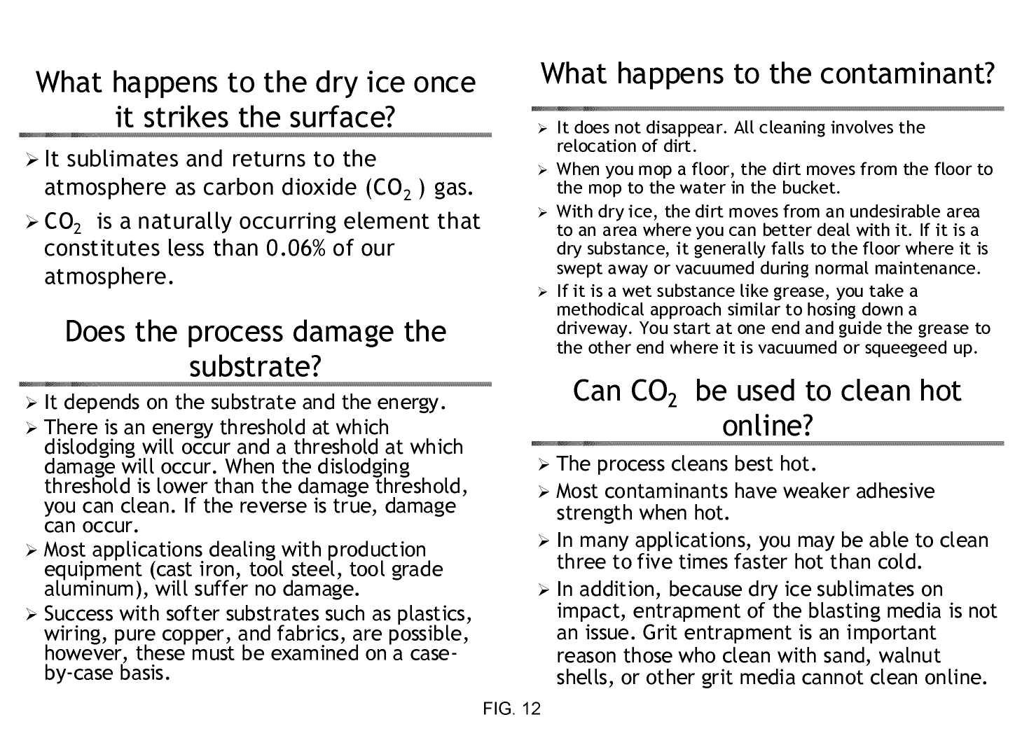

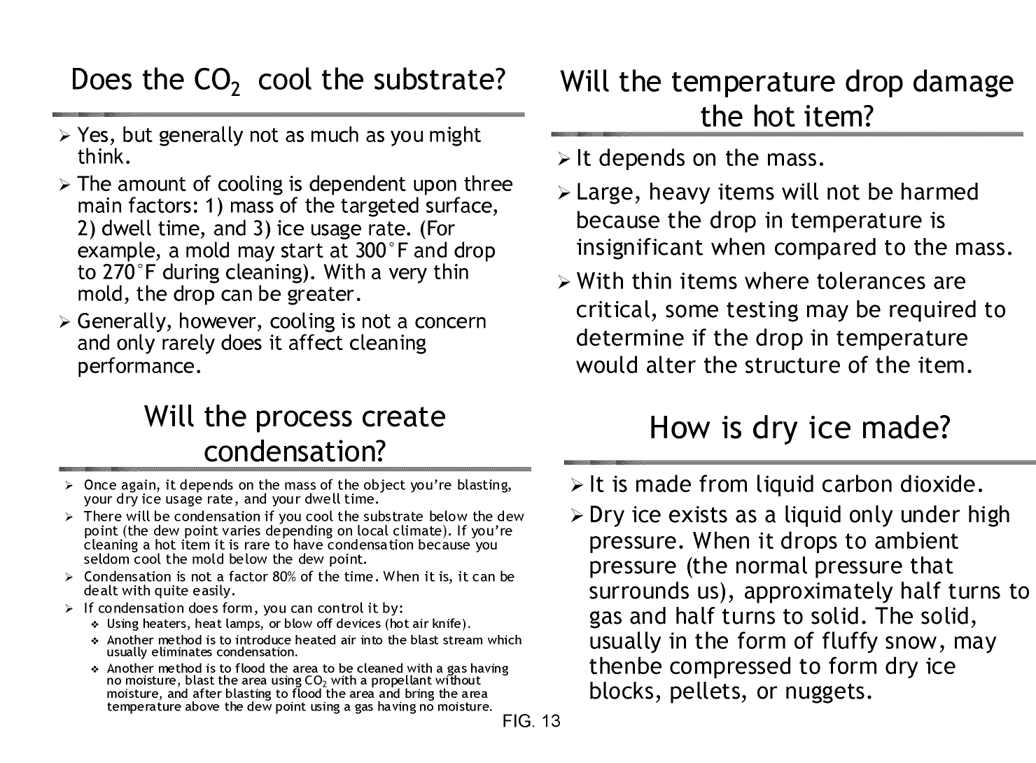

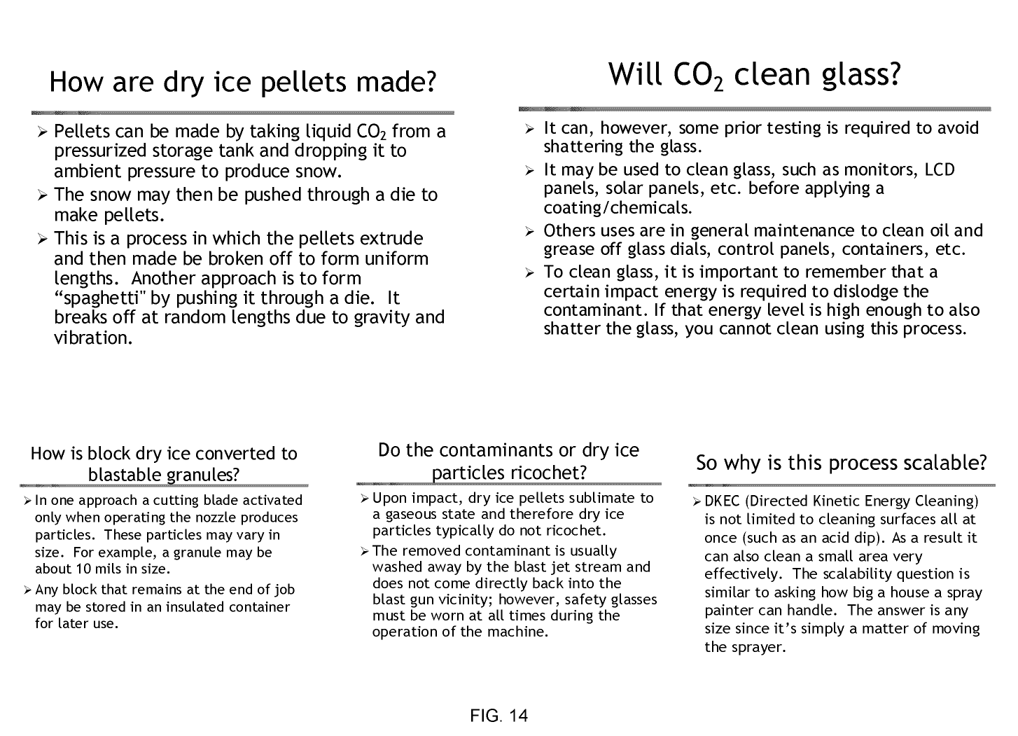

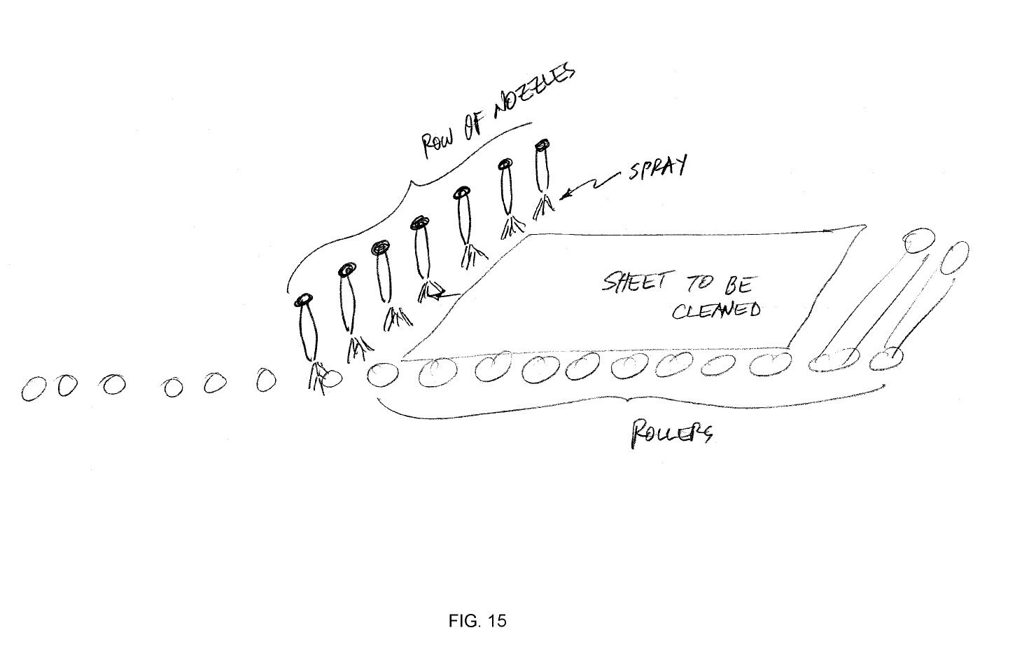

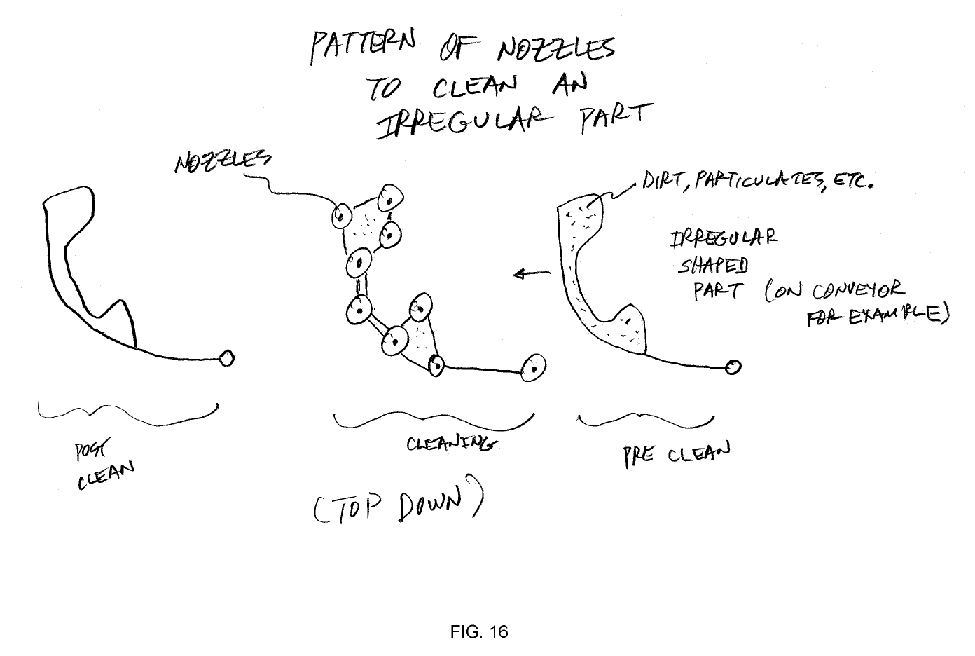

FIGS. 3-21 illustrate various embodiments and features of Directed Kinetic Energy Cleaning (DKEC™).

In one embodiment of the invention, generated particles, such as dry ice, are accelerated toward a surface to be cleaned.

In one embodiment the particles are accelerated via the use of a gas, such as, but not limited to, compressed air, an inert gas, such as nitrogen, or CO₂ (also denoted CO2).

For example, a source of clean compressed air may be used to power a nozzle which propels particles of solid CO₂ (also referred to as dry ice).

In one embodiment of the invention, a series of nozzles may be spaced to provide a “curtain” or row of cleaning capability. Alternatively nozzles may be placed in any pattern needed to clean a part.

In one embodiment the projectiles such as dry ice particles are accelerated and then aimed at the area to be cleaned.

In one embodiment compressed gas and the projectiles are mixed in a chamber and then fed to a nozzle for application to a surface.

In one embodiment to prevent condensation in an area to be cleaned the following approach may be used. Position the nozzle over the area to be cleaned. Next use the nozzle to flood the area with a moisture free gas, such as, but not limited to CO2, nitrogen, moisture free air, etc. so as to displace any moisture that may be near the area to be cleaned. When the area is purged of any moisture then apply the cleaning procedure which should include using moisture-free gases, particles, etc. When the cleaning procedure is completed then again flood the area cleaned with a moisture free gas, such as, but not limited to CO2, nitrogen, moisture free air, etc. so no moisture may enter and continue to do this till the area cleaned is above the dew point. One of skill in the art will appreciate that to speed the warming process a variety of approaches may be used, for example, heated nitrogen, infrared technology, etc.

In one embodiment the area to be cleaned is heated to above ambient temperature and the area flooded with gas to displace moisture, cleaning applied, gas reapplied without further heating and the gas removed when the cleaned area is above the dew point.

While the discussion has detailed the use of frozen CO2, i.e. dry ice, the invention is not so limited.

For example rather than using dry ice, water (H2O) may be used. Environmentally friendly, water may be used in gas form (steam) as a propellant for itself, water, and ice.

The use of ice particles to clean surfaces provides a very environmentally clean approach as well as having several very nice features. For example, depending upon the surface to be cleaned the hardness of the particles being propelled against the surface may benefit from adjust to best clean the surface without damaging it. In one embodiment of the invention ice particles are used for cleaning and the temperature of the ice particles is adjusted. Depending upon the temperature of the ice particles they may be from soft to very hard (e.g. 1.5 Mohs at 0 deg C. to approximately 6 Mohs at −70 deg C.).

In one embodiment of the invention the velocity of the particles may be adjusted, for example by, but not limited to, adjusting the gas pressure of the gas (for example, by using a valve) used to accelerate the particles. By adjusting both the mass and velocity of the particles, the kinetic energy may be adjusted. Recall that KE=(½)mv². Thus by doubling the velocity we can increase the energy of the particles by 4 times. This adjustment and that of adjusting the hardness of, for example ice, plus the mass allows for the adjustment of the directed kinetic energy stream so that the substrate and contaminants thereon may be separated in the most efficient manner.

In one embodiment of the invention the temperature of the particles may be adjusted, for example by, but not limited to, adjusting an electric heater. By adjusting the temperature of the particles, the hardness may be adjusted.

In one embodiment of the invention different streams of particles each at different pressure and temperatures may be mixed together to form a new stream.

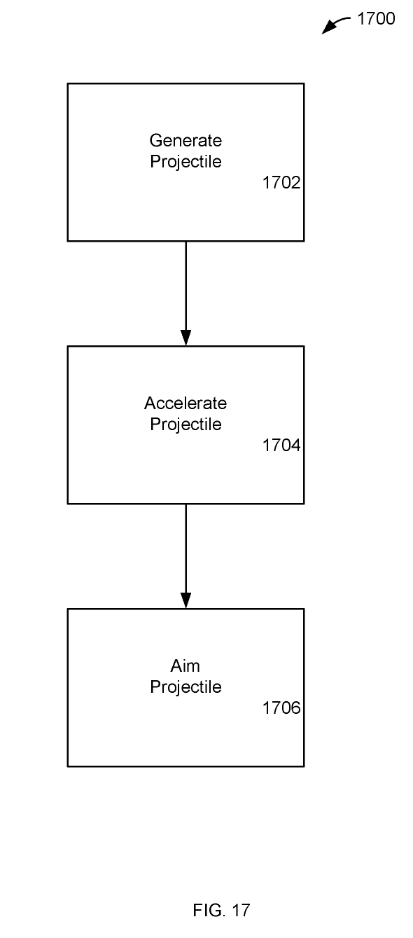

FIG. 17 illustrates, generally at 1700, one embodiment of the invention. At 1702 a projectile is generated. At 1704 the projectile is accelerated. At 1706 the projectile is aimed.

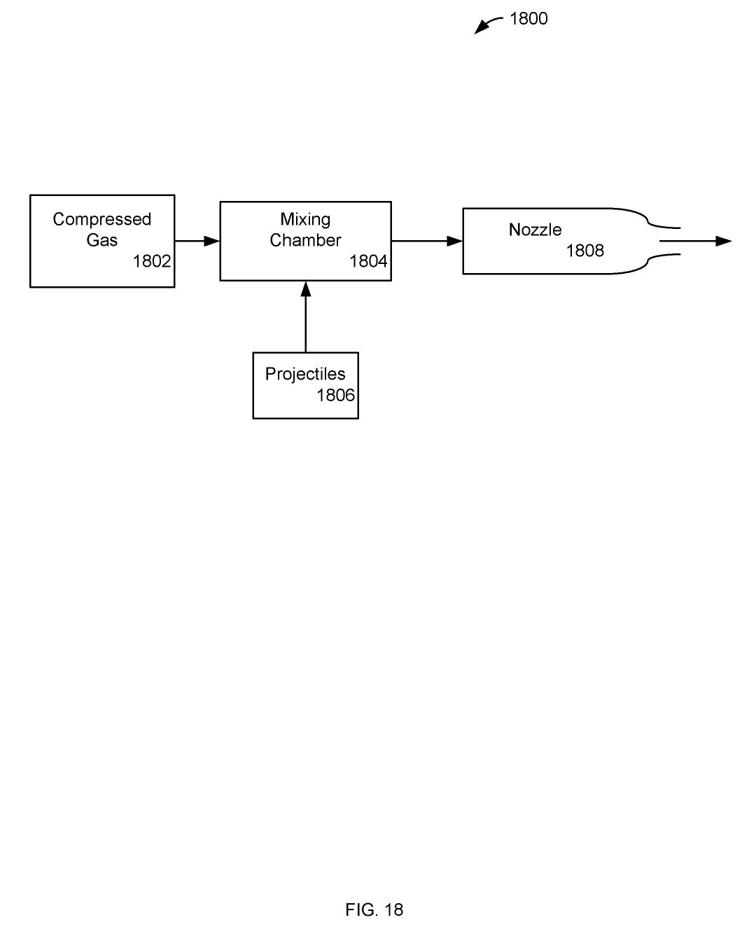

FIG. 18 illustrates, generally at 1800, one embodiment of the invention. At 1802 is a source of compressed gas. At 1806 are projectiles. At 1804 is mixing chamber and at 1808 is a nozzle.

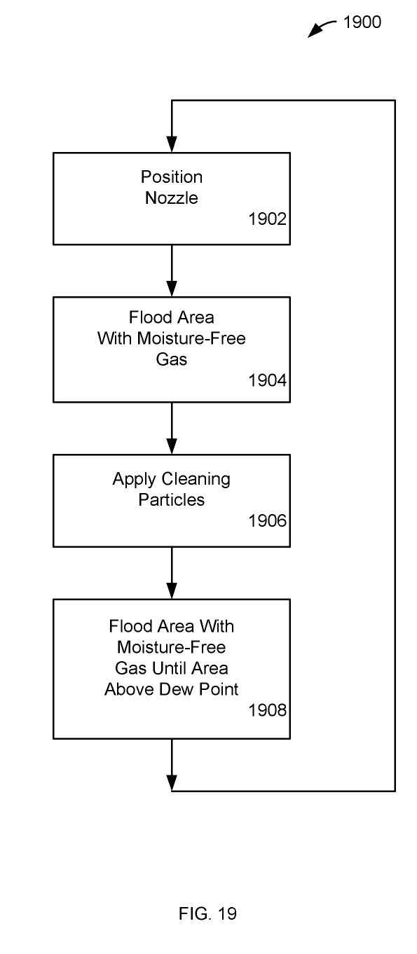

FIG. 19 illustrates, generally at 1900, one embodiment of the invention. At 1902 a nozzle is positioned. At 1906 an area is flooded with moisture-free (or moisture free) gas. At 1906 the cleaning particles are applied. At 1908 the area is flooded with moisture free gas until the area is above dew point. Then the positioning (1902) sequence repeats.

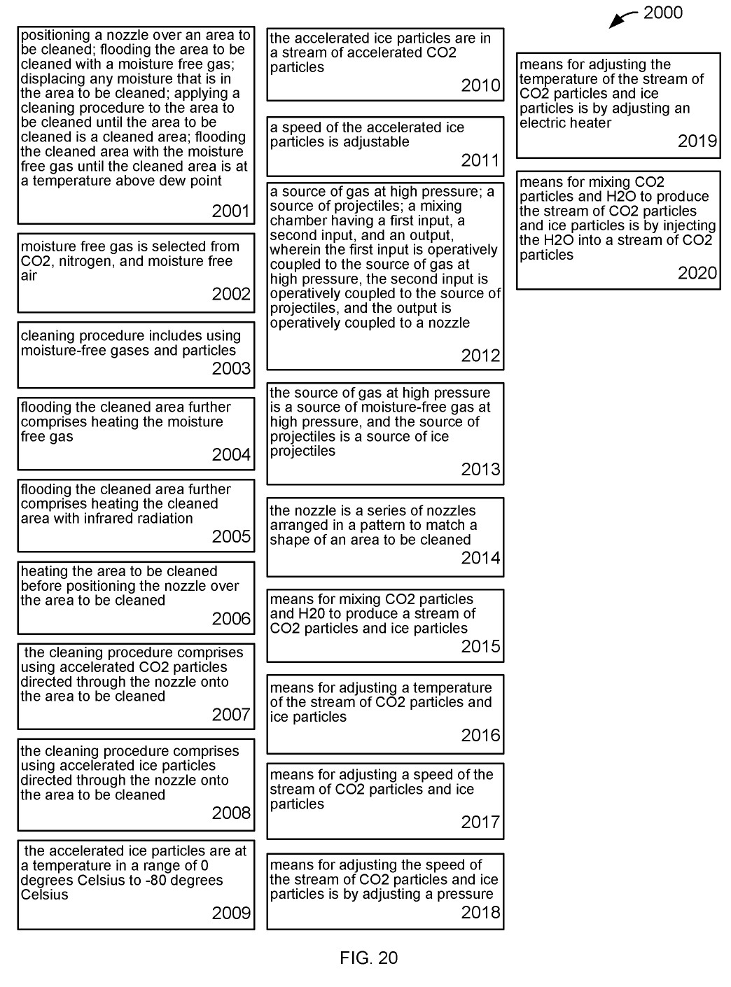

FIG. 20 illustrates, generally at 2000, embodiments of the invention. At 2001 positioning a nozzle over an area to be cleaned; flooding the area to be cleaned with a moisture free gas; displacing any moisture that is in the area to be cleaned; applying a cleaning procedure to the area to be cleaned until the area to be cleaned is a cleaned area; flooding the cleaned area with the moisture free gas until the cleaned area is at a temperature above dew point. At 2002 moisture free gas is selected from CO2, nitrogen, and moisture free air. At 2003 cleaning procedure includes using moisture-free gases and particles. At 2004 flooding the cleaned area further comprises heating the moisture free gas. At 2005 flooding the cleaned area further comprises heating the cleaned area with infrared radiation. At 2006 heating the area to be cleaned before positioning the nozzle over the area to be cleaned. At 2007 the cleaning procedure comprises using accelerated CO2 particles directed through the nozzle onto the area to be cleaned. At 2008 the cleaning procedure comprises using accelerated ice particles directed through the nozzle onto the area to be cleaned. At 2009 the accelerated ice particles are at a temperature in a range of 0 degrees Celsius to −80 degrees Celsius. At 2010 the accelerated ice particles are in a stream of accelerated CO2 particles. At 2011 a speed of the accelerated ice particles is adjustable. At 2012 a source of gas at high pressure; a source of projectiles; a mixing chamber having a first input, a second input, and an output, wherein the first input is operatively coupled to the source of gas at high pressure, the second input is operatively coupled to the source of projectiles, and the output is operatively coupled to a nozzle. At 2013 the source of gas at high pressure is a source of moisture-free gas at high pressure, and the source of projectiles is a source of ice projectiles. At 2014 the nozzle is a series of nozzles arranged in a pattern to match a shape of an area to be cleaned. At 2015 means for mixing CO2 particles and H20 to produce a stream of CO2 particles and ice particles. At 2016 means for adjusting a temperature of the stream of CO2 particles and ice particles. At 2017 means for adjusting a speed of the stream of CO2 particles and ice particles. At 2018 means for adjusting the speed of the stream of CO2 particles and ice particles is by adjusting a pressure. At 2019 means for adjusting the temperature of the stream of CO2 particles and ice particles is by adjusting an electric heater. At 2020 means for mixing CO2 particles and H2O to produce the stream of CO2 particles and ice particles is by injecting the H2O into a stream of CO2 particles.

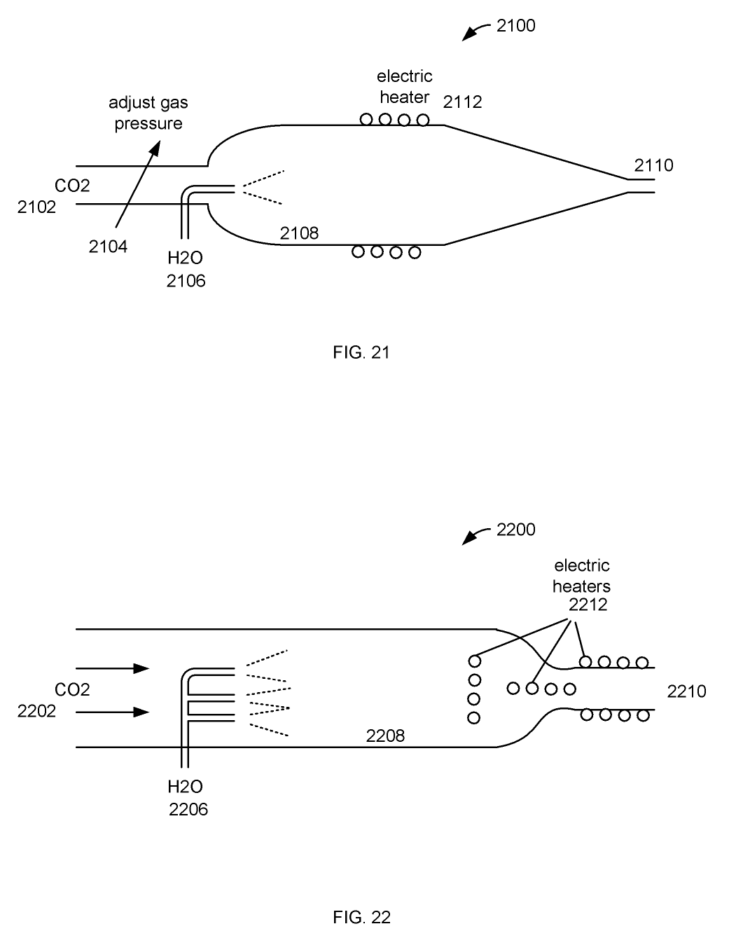

FIG. 21 illustrates, generally at 2100, one embodiment of the invention. At 2102 is a source of CO2 particles and gas. At 2104 is a valve for adjusting the gas pressure. At 2106 a source of water injecting into mixing chamber 2108 with a nozzle 2110 a water stream. At 2112 is an electric heater on the outside of mixing chamber 2108.

FIG. 22 illustrates, generally at 2200, one embodiment of the invention. At 2202 is a source of CO2 particles and gas. At 2206 a source of water injecting into mixing chamber 2208 with a nozzle 2210 several water streams. At 2112 are electric heaters, on the outside and inside of mixing chamber 2208.

One of skill in the art will appreciate that solids other than ice and dry ice may also be used depending upon the nature of the cleaning required. For example, to clean and “bean” a surface as may be desired for adhesion, one may use small “balls” for example of steel, copper, etc.

What is to be appreciated is that by using directed kinetic energy of gases, liquids, and solids and combinations thereof cleaning of surfaces may be achieved.

Thus a method and apparatus for cleaning have been described.

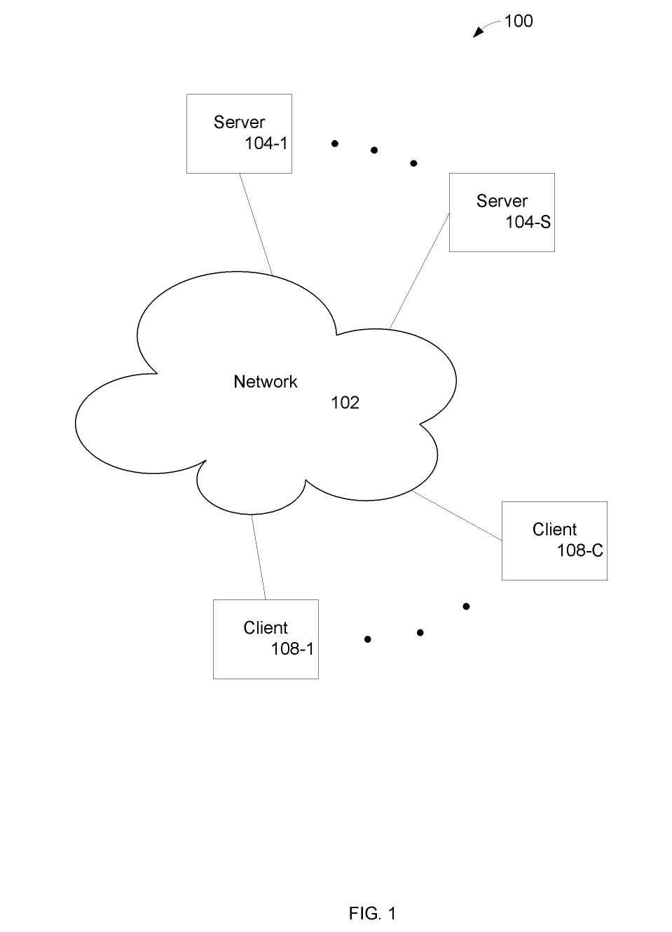

FIG. 1 illustrates a network environment 100 in which the techniques described may be applied. The network environment 100 has a network 102 that connects S servers 104-1 through 104-S, and C clients 108-1 through 108-C. More details are described below.

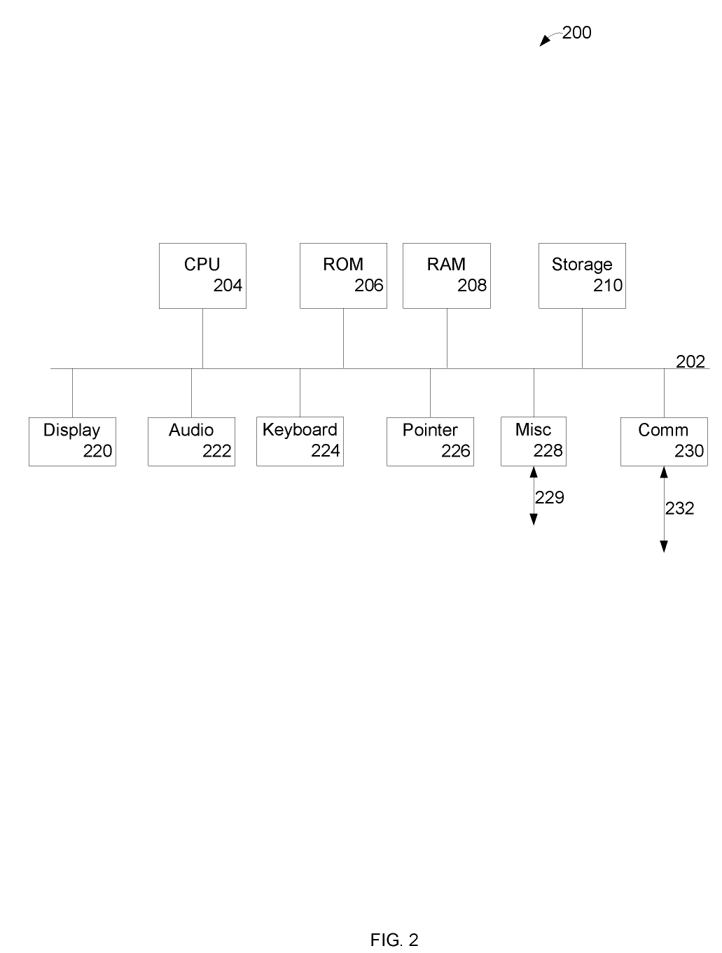

FIG. 2 is a block diagram of a computer system 200 in which some embodiments of the invention may be used and which may be representative of use in any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of communicating means or device whether local or remote, such as a LAN, a WAN, a system bus, etc. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those of skill in the art to describe techniques and approaches. Furthermore, in the description, for purposes of explanation, numerous specific details are set forth in order to provide a thorough understanding of the present invention. It will be evident, however, to one of skill in the art that the present invention may be practiced without these specific details. In some instances, well-known structures and devices are shown in block diagram form, rather than in detail, in order to avoid obscuring the present invention. These embodiments are described in sufficient detail to enable those of skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory, and/or logic circuitry. These algorithmic descriptions and representations are the means used by those of skill in the arts to most effectively convey the substance of their work to others of skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Further, any of the methods according to the present invention can be implemented in hardware, fluidics, hard-wired circuitry, by programmable logic, or by any combination of hardware and software.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk- read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ) as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals capable of causing a physical excitation of matter upon reception (e.g. electrons, atoms, etc.) (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for cleaning have been described.

What is claimed is:

1. A method comprising:
positioning a nozzle over an area to be cleaned;
flooding the area to be cleaned with a moisture free gas;
displacing any moisture that is in the area to be cleaned;
applying a cleaning procedure to the area to be cleaned until the area to be cleaned is a cleaned area;
flooding the cleaned area with the moisture free gas until the cleaned area is at a temperature above dew point.

2. The method of claim 1 wherein the moisture free gas is selected from CO2, nitrogen, and moisture free air.

3. The method of claim 1 wherein the cleaning procedure includes using moisture-free gases and particles.

4. The method of claim 1 wherein flooding the cleaned area further comprises heating the moisture free gas.

5. The method of claim 1 wherein flooding the cleaned area further comprises heating the cleaned area with infrared radiation.

6. The method of claim 1 further comprising heating the area to be cleaned before positioning the nozzle over the area to be cleaned.

7. The method of claim 1 wherein the cleaning procedure comprises using accelerated CO2 particles directed through the nozzle onto the area to be cleaned.

8. The method of claim 1 wherein the cleaning procedure comprises using accelerated ice particles directed through the nozzle onto the area to be cleaned.

9. The method of claim 8 wherein the accelerated ice particles are at a temperature in a range of 0 degrees Celsius to −80 degrees Celsius.

10. The method of claim 8 wherein the accelerated ice particles are in a stream of accelerated CO2 particles.

11. The method of claim 8 wherein a speed of the accelerated ice particles is adjustable.

12. An apparatus comprising:
a source of gas at high pressure;
a source of projectiles;
a mixing chamber having a first input, a second input, and an output, wherein the first input is operatively coupled to the source of gas at high pressure, the second input is operatively coupled to the source of projectiles, and the output is operatively coupled to a nozzle.

13. The apparatus of claim 12 wherein the source of gas at high pressure is a source of moisture-free gas at high pressure, and the source of projectiles is a source of ice projectiles.

14. The apparatus of claim 12 wherein the nozzle is a series of nozzles arranged in a pattern to match a shape of an area to be cleaned.

15. An apparatus comprising:
means for mixing CO2 particles and H2O to produce a stream of CO2 particles and ice particles.

16. The apparatus of claim 15 further comprising means for adjusting a temperature of the stream of CO2 particles and ice particles.

17. The apparatus of claim 16 further comprising means for adjusting a speed of the stream of CO2 particles and ice particles.

18. The apparatus of claim 17 wherein the means for adjusting the speed of the stream of CO2 particles and ice particles is by adjusting a pressure.

19. The apparatus of claim 18 wherein the means for adjusting the temperature of the stream of CO2 particles and ice particles is by adjusting an electric heater.

20. The apparatus of claim 19 wherein the means for mixing CO2 particles and H2O to produce the stream of CO2 particles and ice particles is by injecting the H2O into a stream of CO2 particles.
